(19) United States
(12) Patent Application Publication
(10) Pub. No.: US 2025/0266492 A1
(43) Pub. Date: Aug. 21, 2025

(54) BATTERY

(71) Applicant: TOYOTA JIDOSHA KABUSHIKI KAISHA, Toyota-shi (JP)

(72) Inventors: Yuki ARAI, Toyota-shi (JP); Masahiro IWASAKI, Nagoya-shi (JP)

(73) Assignee: TOYOTA JIDOSHA KABUSHIKI KAISHA, Toyota-shi (JP)

(21) Appl. No.: 18/935,686

(22) Filed: Nov. 4, 2024

(30) Foreign Application Priority Data
Feb. 16, 2024 (JP) 2024-022171

(51) Int. Cl. H01M 10/0525; H01M 10/0585

(52) U.S. Cl. CPC H01M 10/0525; H01M 10/0585

(57) ABSTRACT

A battery having a laminate in which an anode current collector layer, an anode active material layer, an electrolyte layer, and a cathode active material layer are laminated in this order, and at least one end portion of the laminate, a tip end of the anode active material layer is present inside a tip end of the anode current collector layer, a tip end of the electrolyte layer is present inside the tip end of the anode active material layer, a tip end of the cathode active material layer is present inside the tip end of the electrolyte layer, an insulating end member is arranged side by side on an end face of the cathode active material layer, and an end face of the electrolyte layer and an end face of the anode active material layer are covered with an insulating end member.

### CROSS-REFERENCE TO RELATED APPLICATION

This application claims priority to Japanese Patent Application No. 2024-022171 filed on Feb. 16, 2024, incorporated herein by reference in its entirety.

### BACKGROUND

### 1. Technical Field

The present disclosure relates to a battery.

### 2. Description of Related Art

In manufacture of a battery, an electrode mixture slurry is generally applied to a current collector and dried to form an electrode active material layer. In such an electrode active material layer, an end of the electrode mixture slurry coating film may be wet and spread until the electrode mixture slurry coating film is dried, thereby generating a so-called drip portion in the electrode active material layer. There is known the following coating apparatus for suppressing generation of a drip portion of an electrode active material layer.

Japanese Unexamined Patent Application Publication No. 2015-020098 (JP 2015-020098 A) discloses a coating apparatus that includes a die for applying a coating liquid to a foil with one end including lip portions formed on both sides of a slit for ejecting the coating liquid. The width direction of the lip portions is inclined relative to the width direction of the foil. The coating apparatus of JP 2015-020098 A that applies the coating liquid to the foil with the die can suppress variations in the basis weight of a coating region due to generation of a drip portion.

### SUMMARY

For example, it is assumed that a battery is manufactured by applying and laminating an anode active material layer, an electrolyte layer, and a cathode active material layer in this order on an anode current collector layer. For example, in order to suppress a short circuit of the battery in this case, specifically, in order to prevent the cathode active material layer from coming into contact with the anode current collector layer, the anode active material layer, and the electrolyte layer, it is necessary to apply slurry for forming the layers in consideration of the drip portions of the layers. In such a battery, the drip portion has a multi-stage structure, and the volume efficiency of the battery decreases.

Therefore, an object of the present disclosure is to provide a battery in which the volume efficiency of the battery can be improved.

The present disclosure achieves the above object by the following means.

### First Aspect

A battery includes
a laminate in which an anode current collector layer, an anode active material layer, an electrolyte layer, and a cathode active material layer are laminated in the stated order.
In at least one end of the laminate,
a tip of the anode active material layer is located on an inner side of a tip of the anode current collector layer,
a tip of the electrolyte layer is located on an inner side of the tip of the anode active material layer,
a tip of the cathode active material layer is located on an inner side of the tip of the electrolyte layer,
an insulating end member is juxtaposed to an end face of the cathode active material layer, and
an end face of the electrolyte layer and an end face of the anode active material layer are covered with the insulating end member.

### Second Aspect

In the battery according to the first aspect,
the end face of the anode active material layer may define an inclined surface that approaches the anode current collector layer toward the tip of the anode active material layer.

### Third Aspect

In the battery according to the first or second aspect,
an angle between a tangential direction at a tip of the insulating end member and a surface direction of a surface of the anode current collector layer may be 45° to 90°.

### Fourth Aspect

In the battery according to any one of the first to third aspects,
an angle between a tangential direction at the tip of the cathode active material layer and a surface direction of a surface of the anode current collector layer may be 30° to 110°.

### Fifth Aspect

A method of manufacturing the battery according to any one of the first to fourth aspects includes:
providing a preliminary laminate in which the anode current collector layer, the anode active material layer, and the electrolyte layer are laminated in the stated order; and
forming the insulating end member and the cathode active material layer simultaneously on the preliminary laminate, or forming the insulating end member and then the cathode active material layer on the preliminary laminate.

With the battery of the present disclosure, the volume efficiency of the battery can be improved.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram for explaining a battery of the present disclosure;

FIG. 2 is a schematic diagram for explaining a battery in the prior art;

FIG. 3A is a schematic diagram for describing the tangent;

FIG. 3B is a schematic diagram for describing the tangent;

FIG. 4A is a schematic diagram illustrating a method of manufacturing a battery according to an embodiment of the present disclosure;

FIG. 4B is a schematic diagram illustrating a method of manufacturing a battery according to an embodiment of the present disclosure;

FIG. 5A is a schematic diagram for illustrating another aspect of the disclosed methods of making batteries;

FIG. 5B is a schematic diagram for illustrating another aspect of the methods of making the cells of the present disclosure; and

FIG. 5C is a schematic diagram for illustrating another aspect of the methods of manufacturing batteries of the present disclosure.

### DETAILED DESCRIPTION OF EMBODIMENTS

Hereinafter, embodiments of the present disclosure will be described in detail. Note that the present disclosure is not limited to the following embodiments, and various modifications can be made within the scope of the gist of the present disclosure. In the description of the drawings, the same elements are denoted by the same reference numerals, and redundant description will be omitted.

In the present disclosure, the battery may be a liquid-based battery containing an electrolyte solution as an electrolyte layer, or may be a solid battery having a solid electrolyte layer as an electrolyte layer. In the context of the present disclosure, a “solid battery” means a battery using at least a solid electrolyte as an electrolyte, and therefore a solid battery may use a combination of a solid electrolyte and a liquid electrolyte as an electrolyte. Further, in the present disclosure, the battery may be an all-solid-state battery, that is, a battery using only a solid electrolyte as an electrolyte.

### Battery

The battery of the present disclosure includes:
The anode current collector layer, the anode active material layer, the electrolyte layer, and the cathode active material layer are laminated in this order.
At least one end of the laminate,
The tip of the anode active material layer is located inside the tip of the anode current collector layer,
The tip of the electrolyte layer is located inside the tip of the anode active material layer,
The front end of the cathode active material layer is located inside the front end of the electrolyte layer,
An insulating end member is juxtaposed on an end face of the cathode active material layer, and
An end face of the electrolyte layer and an end face of the anode active material layer are covered with the insulating end member.

According to the battery of the present disclosure, the volume efficiency of the battery can be improved.

Although not limited to the theory, in the present disclosure, by arranging the insulating end members side by side on the end face of the cathode active material layer, generation of the sagging portion of the cathode active material layer can be suppressed, and the volume of the sagging portion of the cathode active material layer can be reduced. Thereby, the volume efficiency of the battery is improved. In the related art that does not use the insulating end member of the present disclosure, the sagging portion of the cathode active material layer often has an angle of less than 30° between the tangential direction at the front end of the cathode active material layer and the surface direction of the surface of the anode current collector layer.

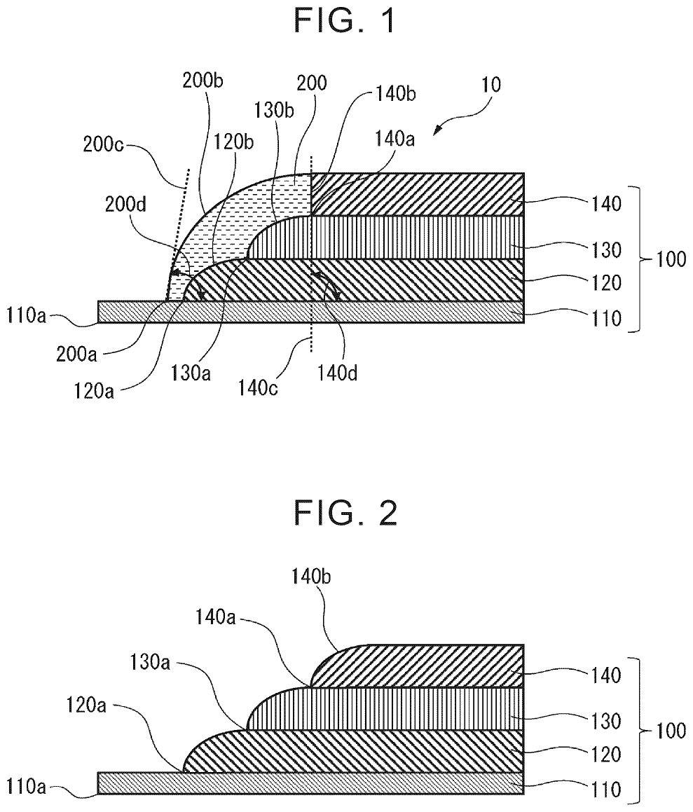

FIG. 1 is a schematic diagram illustrating one embodiment of a battery of the present disclosure, but is not limited thereto. On the other hand, FIG. 2 is a schematic diagram showing one embodiment of a battery in the prior art.

FIG. 1 is a schematic cross-sectional view of a periphery of an end portion of a laminate in a battery of the present disclosure. The laminate 100 of the battery 10 of the present disclosure is a laminate in which the anode current collector layer 110, the anode active material layer 120, the electrolyte layer 130, and the cathode active material layer 140 are stacked in this order. At the end portion of the laminate 100, the leading end 120a of the anode active material layer is located inside the leading end 110a of the anode current collector layer, and the leading end 130a of the electrolyte layer is located inside the leading end 120a of the anode active material layer. The front end 140a of the cathode active material layer is located inside the leading end 130a of the electrolyte layer. Further, an insulating end member 200 is arranged side by side on the end face 140b of the cathode active material layer, and the end face 130b of the electrolyte layer and the end face 120b of the anode active material layer are covered with the insulating end member 200. The insulating end member 200 arranged side by side on the end face 140b of the cathode active material layer can suppress generation of sagging portions of the cathode active material layer 140 and improve the volume-efficiency of the batteries.

FIG. 2 is a schematic cross-sectional view of a battery according to the prior art around an end portion of a laminate. The battery in the prior art illustrated in FIG. 2 is, 30 for example, a battery obtained when a positive electrode mixture slurry is applied to a surface of an electrolyte layer and dried to form a cathode active material layer, and the cathode active material layer also has a sagging portion. Specifically, in FIG. 2, the laminate 100 is a laminate in which the anode current collector layer 110, the anode active material layer 120, the electrolyte layer 130, and the cathode active material layer 140 are stacked in this order, similarly to the battery of the present disclosure. At the end portion of the laminate 100, the leading end 120a of the anode active material layer is located inside the leading end 110a of the anode current collector layer, and the leading end 130a of the electrolyte layer is located inside the leading end 120a of the anode active material layer. The front end 140a of the cathode active material layer is located inside the leading end 130a of the electrolyte layer. However, unlike the disclosed batteries, the insulating end member 200 is not provided on the end face 140b of the cathode active material layer, and the end face 140b of the cathode active material layer forms an inclined surface that approaches the electrolyte layer 130 toward the front end 140a of the cathode active material layer. Since the end face of the cathode active material layer forms such an inclined surface (so-called sagging portion), the volume efficiency of the battery is reduced as compared with the battery of the present disclosure.

The leading end of the cathode active material layer is not particularly limited, but may be disposed 1.8 mm to 3.5 mm inside from the leading end of the anode active material layer. The leading end of the cathode active material layer is not particularly limited, but may be disposed 0 mm to 1.7 mm inside from the leading end of the electrolyte layer.

In the battery of the present disclosure, the end surface of the anode active material layer is not particularly limited, but may form an inclined surface that approaches the anode current collector layer toward the front end of the anode active material layer. Similarly, the end surface of the electrolyte layer is not particularly limited, but may form an inclined surface that approaches the anode active material layer toward the front end of the electrolyte layer.

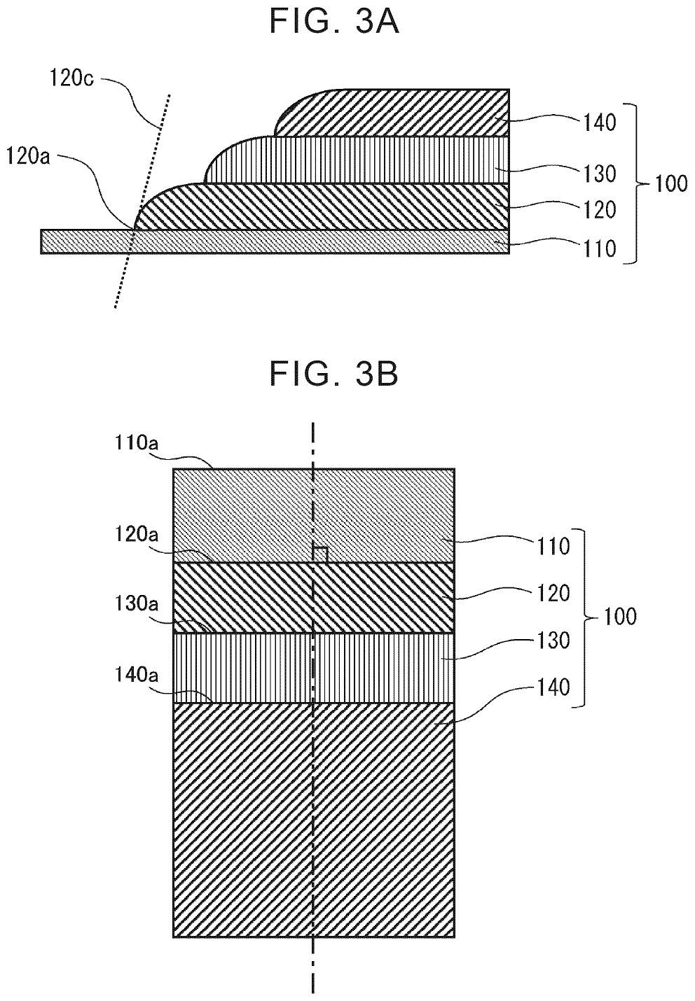

In FIG. 1 described above, the anode active material layer 120 is formed on the anode current collector layer 110, and the end face 120b of the anode active material layer forms an inclined surface that approaches the anode current collector layer 110 toward the leading end 120a of the anode active material layer. For example, when the negative electrode mixture slurry is coated on the surface of the anode current collector layer and dried to form the anode active material layer, the end surface of the anode active material layer as illustrated in FIG. 3A may form an inclined surface. The angle of the inclined surface of the anode active material layer between the tangential direction at the tip of the anode active material layer and the surface direction of the surface of the anode current collector layer is not particularly limited, but may be 0.8° or more. The electrolyte layer 130 is formed on the anode active material layer 120, and the end face 130b of the electrolyte layer forms an inclined surface that approaches the anode active material layer 120 toward the leading end 130a of the electrolyte layer. For example, when the electrolyte mixture slurry is coated on the surface of the anode active material layer and dried to form the electrolyte layer, the end face of the electrolyte layer as illustrated in FIG. 3A may form an inclined surface. An insulating end member 200 is arranged side by side on the end face 140b of the cathode active material layer, and the end face 130b of the electrolyte layer and the end face 120b of the anode active material layer are covered with the insulating end member 200. Even when the anode active material layer or the electrolyte layer has an inclined surface, the generation of sagging portions of the cathode active material layer 140 can be suppressed by the insulating end member 200 arranged side by side on the end face 140b of the cathode active material layer, thereby improving the volume-efficiency of the cell.

In the battery of the present disclosure, the angle between the tangential direction at the tip end of the insulating end member and the surface direction of the surface of the anode current collector layer is not particularly limited, but is preferably 45° to 90°. The angle between the tangential direction at the tip of the insulating end member and the surface direction of the surface of the anode current collector layer may be, for example, 45° or more, 50° or more, 55° or more, 60° or more, 70° or more, or 75° or more. The angle between the tangential direction at the tip of the insulating end member and the surface direction of the surface of the anode current collector layer may be, for example, 90° or less, 85° or less, or 80° or less.

In FIG. 1 described above, the end face 200b of the insulating end member forms an inclined surface that approaches the anode current collector layer 110 toward the distal end 200a of the insulating end member. The tangential direction 200c at the distal end of the insulating end member is a direction tangential to the end face 200b of the insulating end member on the distal end 200a of the insulating end member. The angular 200d between the tangential direction at the distal end of the insulating end member and the surface direction of the anode current collector layers is not particularly limited, but is preferably 45° to 90°. From the viewpoint of covering the end face 130b of the electrolyte layer and the end face 120b of the anode active material layer by the insulating end member 200, and from the viewpoint of the volume-efficiency of the cell, the angular 200d is not particularly limited, but is preferably 45° to 90°.

In the battery of the present disclosure, the angle between the tangential direction at the tip of the cathode active material layer and the surface direction of the surface of the anode current collector layer is not particularly limited, but is preferably 30° to 110°. The angle between the tangential direction at the tip of the cathode active material layer and the surface direction of the surface of the anode current collector layer may be, for example, 30° or more, 35° or more, 40° or more, 45° or more, 50° or more, or 55° or more. The angle between the tangential direction at the tip of the cathode active material layer and the surface direction of the surface of the anode current collector layer may be, for example, 60° or more, 65° or more, 70° or more, 75° or more, 80° or more, 85° or more, or 90° or more. The angle between the tangential direction at the tip of the cathode active material layer and the surface direction of the surface of the anode current collector layer may be, for example, 110° or less, 105° or less, 100° or less, 95° or less, or 90° or less.

In FIG. 1 described above, the tangential direction 140c at the front end of the cathode active material layer is a tangential direction at the front end 140a of the cathode active material layer in the end face 140b of the cathode active material layer. The angular 140d between the tangential direction at the front end of the cathode active material layer and the surface direction of the surface of the anode current collector layer is not particularly limited from the viewpoint of suppressing the sagging portion of the cathode active material layer, but is preferably 50 to 110.

In the present disclosure, “tangent line” means a tangent line in a cross section perpendicular to the plane direction of each layer and perpendicular to the line formed by the tip of each layer. FIGS. 3A and 3B are schematic diagrams for describing a “tangent line”, but are not limited thereto. FIG. 3B is a schematic view of FIG. 3A viewed from the front side of the cathode active material layer. For example, a tangent 120c of the anode active material layer illustrated by a dotted line in FIG. 3A is a tangent line in a cross section perpendicular to the plane of the anode active material layer 120 and perpendicular to the line formed by the leading end 120a of the anode active material layer. Specifically, a cross section perpendicular to the plane of the anode active material layer 120 and perpendicular to the line formed by the leading end 120a of the anode active material layer is a cross section cut at a cutting position illustrated by a dashed-dotted line in FIG. 3B. The same applies to the tangent lines of the other layers.

### Battery Manufacturing Method

The battery of the present disclosure can be manufactured by a method including the following steps:
Providing a preliminary laminate in which an anode current collector layer, an anode active material layer, and an electrolyte layer are laminated in this order; and
The insulating end member and the cathode active material layer are simultaneously formed on the preliminary laminate, or the insulating end member is formed, and then the cathode active material layer is formed.

According to the battery manufacturing method of the present disclosure, generation of a sagging portion of the cathode active material layer can be suppressed.

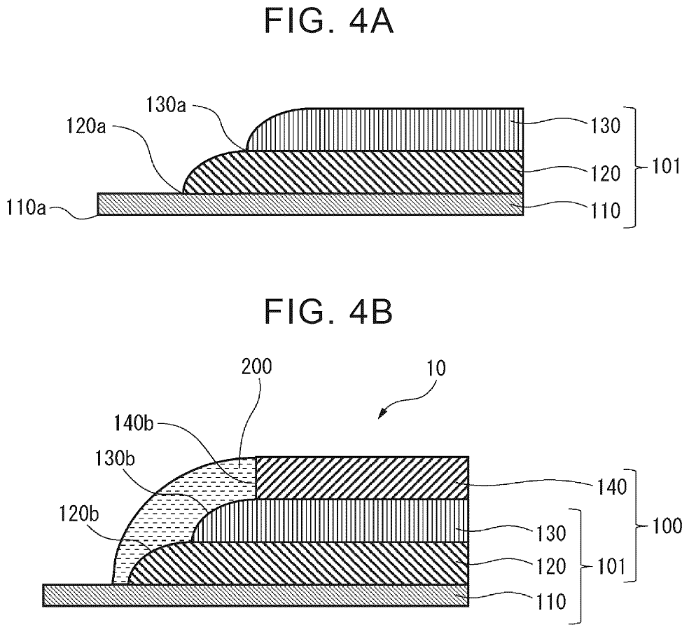

FIGS. 4A and 4B are schematic illustrations illustrating one embodiment of the disclosed methods of fabricating batteries, but are not limited thereto.

The methods of manufacturing the presently disclosed cells first provide a preliminary laminate 101 as shown in FIG. 4A. The preliminary laminate 101 is a laminate in which an anode current collector layer 110, an anode active material layer 120, and an electrolyte layer 130 are laminated in this order. At least one end portion of the preliminary laminate 101, the leading end 120a of the anode active material layer is located inside the leading end 110a of the anode current collector layer, and the leading end 130a of the electrolyte layer is located inside the leading end 120a of the anode active material layer. Next, as shown in FIG. 4B, the insulating end member 200 and the cathode active material layer 140 are simultaneously formed on the preliminary laminate 101. At this time, the insulating end member 200 is formed so as to cover the end face 130b of the electrolyte layer and the end face 120b of the anode active material layer. The method of simultaneously forming the insulating end member 200 and the cathode active material layer 140 is not particularly limited. However, a partition may be provided inside the die head of the die coater, and the insulating end member paste and the positive electrode mixture slurry, which will be described later, may be applied simultaneously to form the insulating end member and the cathode active material layer at the same time. By simultaneously forming the insulating end member 200 and the cathode active material layer 140 in this manner, the insulating end member 200 is arranged side by side on the end face 140b of the cathode active material layer, whereby generation of sagging portions of the cathode active material layer 140 can be suppressed.

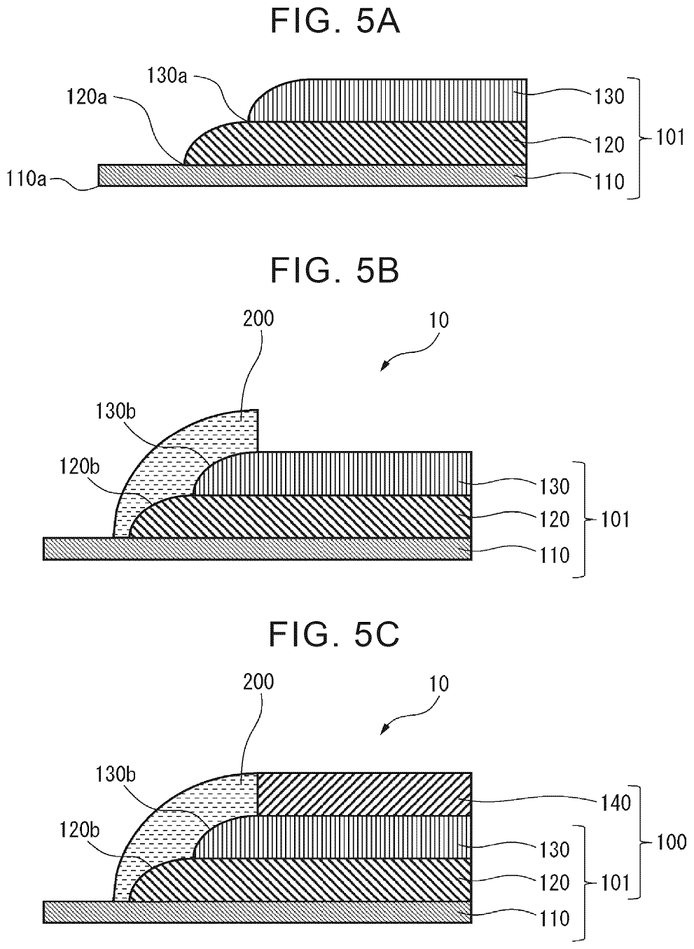

FIGS. 5A, 5B, and 5C are schematic illustrations illustrating one embodiment of the disclosed methods of manufacturing batteries, but are not limited thereto.

In another aspect of the disclosed methods of manufacturing batteries, a preliminary laminate 101 is first provided, as shown in FIG. 5A. The preliminary laminate 101 is a laminate in which the anode current collector layer 110, the anode active material layer 120, and the electrolyte layer 130 are stacked in this order. At least one end portion of the preliminary laminate 101, the leading end 120a of the anode active material layer is located inside the leading end 110a of the anode current collector layer, and the leading end 130a of the electrolyte layer is located inside the leading end 120a of the anode active material layer. Next, as shown in FIG. 5B, an insulating end member 200 is formed to cover the end face 130b of the electrolyte layer and the end face 120b of the anode active material layer. Then, as shown in FIG. 5C, the cathode active material layer 140 is formed. By forming the insulating end member 200 in this manner and then forming the cathode active material layer 140, the wetting and spreading of the cathode active material layer is blocked by the insulating end member 200, whereby the generation of sagging portions of the cathode active material layer 140 can be suppressed.

### Battery and Method of Manufacturing Battery; Respective Components

Hereinafter, each configuration of a battery and a method of manufacturing the battery will be described.

In the context of the present disclosure, a “mixture” means a composition capable of forming a cathode active material layer or the like as it is or by further containing other components. In addition, in the context of the present disclosure, the “mixture slurry” means a slurry that includes a dispersion medium in addition to the “mixture” and that can be applied and dried to form a cathode active material layer or the like.

### Laminate

In the battery of the present disclosure, the laminate includes an insulating end member, an anode current collector layer, an anode active material layer, an electrolyte layer, and a cathode active material layer. In the battery of the present disclosure, the laminate is not particularly limited, but may further include a positive electrode current collector layer.

### Insulating End Member

The material of the insulating end member is not particularly limited as long as it is an insulator. Examples of the insulating end member include butadiene rubber (BR), styrene-butadiene rubber (SBR), acrylic-butadiene rubber (ABR), nitrile-butadiene rubber (NBR), and polyimide. However, the material of the insulating end member is not limited to these cases.

The insulating end member can be formed so as to cover the end face of the electrolyte layer and the end face of the anode active material layer by, for example, applying an insulating end member paste containing an insulating end member and a solvent, drying, and removing the solvent.

The insulating end member paste is not particularly limited, but preferably does not react with the positive electrode mixture or the positive electrode mixture slurry. The viscosity of the insulating end member paste is not particularly limited, but is preferably higher than that of the positive electrode mixture or the positive electrode mixture slurry. For example, the viscosity of the insulating end member paste may be 1.0 Pa·s or more, 5.0 Pa·s or more, or 10 Pa·s or more, and may be 100 Pa·s or less, 50 Pa·s or less, or 30 Pa·s or less. Here, the viscosity of the insulating end member paste can be measured by an E-type viscometer at 23° C.

### Anode Current Collector Layer

A material used for the anode current collector layer is not particularly limited, but a material generally used as a negative electrode current collector of a battery can be appropriately adopted. Examples of the material used for the anode current collector layer include, but are not limited to, Cu, Ni, Cr, Au, Pt, Ag, Al, Fe, Ti, Zn, Co, stainless-steel, and carbon sheet. The anode current collector layer may have some coating layer on the surface thereof for the purpose of adjusting resistance or the like.

The shape of the anode current collector layer is not particularly limited, but may be, for example, a foil shape, a plate shape, or a mesh shape. Among them, a foil shape is preferable.

The thickness of the anode current collector layers is not particularly limited, but may be 0.1 μm or more, or 1 μm or more, and may be 1 mm or less, or 100 μm or less.

### Anode Active Material Layer

The anode active material layer includes at least a negative electrode active material, and may further optionally include a solid electrolyte, a conductive auxiliary agent, a binder, and the like. The anode active material layer may further contain various additives. The content of each of the negative electrode active material, the solid electrolyte, the conductive auxiliary agent, the binder, and the like in the anode active material layer may be appropriately determined in accordance with the desired battery performance. For example, the content of the negative electrode active material may be 40% by mass or more, 50% by mass or more, or 60% by mass or more, and may be 100% by mass or less, or 90% by mass or less, with the total (total solid content) of the anode active material layer being 100% by mass.

### Negative Electrode Active Material

As the negative electrode active material, various materials having a potential at which lithium ions are occluded and released (charge and discharge potential) which is a lower potential than a positive electrode active material described later may be employed. The material of the negative electrode active material is not particularly limited, and may be metallic lithium or a material capable of occluding and releasing metallic ions such as lithium ions. Examples of the material capable of occluding and releasing metal ions such as lithium ions include, but are not limited to, alloy-based negative electrode active materials, carbon materials, and lithium titanate (Li₄Ti₅O₁₂).

The alloy-based negative electrode active material is not particularly limited, and examples thereof include an Si alloy-based negative electrode active material, and an Sn alloy-based negative electrode active material. The Si alloy-based negative electrode active materials include silicon, silicon oxides, silicon carbides, silicon nitrides, and solid solutions thereof. The Si alloy-based negative electrode active material may include a metallic element other than silicon, for example, Fe, Co, Sb, Bi, Pb, Ni, Cu, Zn, Ge, In, Sn, and Ti. The Sn alloy-based negative electrode active materials include tin, tin oxide, tin nitride, and solid solutions thereof. The Sn alloy-based negative electrode active material may include a metallic element other than tin, for example, Fe, Co, Sb, Bi, Pb, Ni, Cu, Zn, Ge, In, Ti, and Si.

The carbon material is not particularly limited, and examples thereof include hard carbon, soft carbon, and graphite.

The shape of the negative electrode active material is not particularly limited, but may be any general shape as the negative electrode active material of the battery. The negative electrode active material may be, for example, in a particulate form or a sheet form.

### Solid Electrolyte

The material of the solid electrolyte is not particularly limited, and may be, for example, a sulfide solid electrolyte, an oxide solid electrolyte, or a polymer electrolyte.

Examples of the sulfide solid electrolyte include, but are not limited to, a sulfide-based amorphous solid electrolyte, a sulfide-based crystalline solid electrolyte, and an aldirodite-type solid electrolyte. Examples of a specific sulfide solid-electrolyte include: Li₂S—P₂S₅ system, Li₂S—SiS₂, LiI—Li₂S—SiS₂, LiI-Li₂S—P₂S₅, LiI—LiBr—Li₂S—P₂S₅, Li₂S—P₂S₅—GeS₂, LiI—Li₂S—P₂O₅, LiI—Li₃PO₄—P₂S₅, and Li₇₋ₓPS₆₋ₓClₓ; and combinations thereof. However, examples of the sulfide solid electrolyte are not limited thereto. The Li₂S—P₂S₅ system is Li₇P₃S₁₁, Li₃PS₄, Li₈P₂S₉, and the like. Li₂S—P₂S₅—GeS₂ is Li₁₃GeP₃S₁₆, Li₁₀GeP₂S₁₂, and the like.

Examples of the oxide solid electrolyte include: Li₇La₃Zr₂O₁₂, Li₇₋ₓLa₃Zr₁₋ₓNbₓO₁₂, Li₇₋₃ₓLa₃Zr₂AlₓO₁₂, Li₃ₓLa_{2/3-x}TiO₃, Li₁₊ₓAlₓTi₂₋ₓ(PO₄)₃, Li₁₊ₓAlₓGe₂₋ₓ(PO₄)₃, Li₃PO₄, and Li₃₊ₓPO₄₋ₓNₓ(LiPON); and combinations thereof. However, examples of the oxide solid electrolyte are not limited thereto.

The sulfide solid electrolyte and the oxide solid electrolyte may be glass or crystallized glass (glass ceramics).

Examples of polymer electrolytes include polyethylene oxide (PEO), polypropylene oxide (PPO), and copolymers thereof, but are not limited to these.

### Conductive Aid

The conductive aid is not particularly limited. Examples of the conductive aid may be, but are not limited to, vapor-grown carbon fiber (VGCF), acetylene black (AB), Ketjen black (KB), carbon nanotube (CNT), and carbon nanofiber (CNF). The conductive auxiliary agent may be, for example, particulate or fibrous, and the size thereof is not particularly limited. The conductive auxiliary agent is not particularly limited, but only one kind may be used alone, or two or more kinds may be used in combination.

### Binder

The binder is not particularly limited. The binder may be a material such as, but are not limited to, polyvinylidene fluoride (PVdF), butadiene rubber (BR), polytetrafluoroethylene (PTFE), styrene butadiene rubber (SBR), and the like. The binder is not particularly limited, but only one binder may be used alone, or two or more binders may be used in combination.

The shape of the anode active material layer is not particularly limited, but may be, for example, a sheet-like anode active material layer having a substantially flat surface. The thickness of the anode active material layers is not particularly limited, but may be, for example, 0.1 μm or more, 1 μm or more, or 10 μm or more, and may be 2 mm or less, 1 mm or less, or 500 μm or less.

The anode active material layer can be produced by applying a known method. For example, the anode active material layer can be easily formed by, for example, dry or wet molding of the negative electrode mixture containing the above various components. The anode active material layer may be formed together with the anode current collector layer or may be formed separately from the anode current collector layer.

### Electrolyte Layer-Solid Electrolyte Layer

The battery of the present disclosure may have a solid electrolyte layer as a solid battery, i.e., an electrolyte layer. The solid electrolyte layer includes at least a solid electrolyte, and may optionally include a conductive auxiliary agent, a binder, and the like.

For the solid electrolyte, the conductive auxiliary agent, and the binder, reference can be made to the description of “anode active material layer”.

The thickness of the solid electrolyte layers is not particularly limited, but may be, for example, 0.1 μm or more, 1 μm or more, or 10 μm or more, and may be 2 mm or less, 1 mm or less, or 500 μm or less.

The solid electrolyte layer can be easily formed by, for example, dry or wet molding a solid electrolyte mixture containing the above-described solid electrolyte, binder, and the like.

### Electrolyte Layer-Electrolyte Solution

The battery of the present disclosure may have a liquid-based battery, i.e., an electrolyte retained in an electrolyte, in particular a separator layer, as an electrolyte layer.

### Electrolytic Solution

The electrolyte solution is not particularly limited, but preferably contains a supporting salt and a solvent.

The support salt (lithium salt) of the electrolytic solution having lithium ion conductivity is not particularly limited, and examples thereof include an inorganic lithium salt and an organic lithium salt. Examples of the inorganic lithium salt include, but are not limited to, LiPF₆, LiBF₄, LiClO₄, and LiAsF₆. Examples of the organic lithium salt include, but are not limited to, LiCF₃SO₃, LiN(CF₃SO₂)₂, LiN(C₂F₅SO₂)₂, LiN(FSO₂)₂, and LiC(CF₃SO₂)₃.

The solvent used in the electrolytic solution is not particularly limited, and examples thereof include cyclic carbonate and linear carbonate. Examples of the cyclic carbonate include, but are not limited to, ethylene carbonate (EC), propylene carbonate (PC), and butylene carbonate (BC). Examples of the linear carbonate include, but are not limited to, dimethyl carbonate (DMC), diethyl carbonate (DEC), and ethyl methyl carbonate (EMC). The electrolytic solution is not particularly limited, but only one kind may be used alone, or two or more kinds may be used in combination.

### Separator

The separator is not particularly limited, but a general separator may be appropriately employed as the separator of the battery. Examples of the separator include polyolefin-based, polyamide-based, and polyimide-based nonwoven fabrics.

### Cathode Active Material Layer

The cathode active material layer includes at least a positive electrode active material, and may further optionally include a solid electrolyte, a conductive auxiliary agent, a binder, and the like. The cathode active material layer may further contain various additives. The content of each of the positive electrode active material, the solid electrolyte, the conductive auxiliary agent, the binder, and the like in the cathode active material layer may be appropriately determined in accordance with the desired battery performance. For example, the content of the positive electrode active material may be 40% by mass or more, 50% by mass or more, or 60% by mass or more, or 100% by mass or less, or 90% by mass or less, based on 100% by mass of the entire cathode active material layer (the entire solid content).

### Positive Electrode Active Material

The material of the positive electrode active material is not particularly limited as long as it can occlude and release lithium ions. Examples of the positive electrode active material include lithium cobaltate (LiCoO₂), lithium nickelate (LiNiO₂), and lithium manganate (LiMn₂O₄). Further, the positive electrode active material may be, for example, nickel cobalt manganate (NCM: LiCO_{1/3}Ni_{1/3}Mn_{1/3}O₂), nickel cobalt aluminum oxide (LiNi_{0.8}(CoAl)_{0.2}O₂), and the like. The positive electrode active material may be, for example, a heterogeneous element-substituted Li—Mn spinel having a composition represented by Li₁₊ₓMn_{2-x-y}M_{y}O₄ (M is one or more metallic elements selected from Al, Mg, Co, Fe, Ni, and Zn). However, the positive electrode active material is not limited thereto.

The positive electrode active material is not particularly limited, but may have a coating layer. The coating layer is a layer containing a material having lithium ion conductivity, having low reactivity with a positive electrode active material or a solid electrolyte, and capable of maintaining a form of a coating layer that does not flow even when in contact with an active material or a solid electrolyte. Specific examples of materials constituting the coating layer include, in addition to LiNbO₃, Li₄Ti₅O₁₂, and Li₃PO₄, but are not limited thereto.

The shape of the positive electrode active material is not particularly limited as long as it has a general shape as the positive electrode active material of the battery. The positive electrode active material may be in a particulate form, for example. The positive electrode active material may be a primary particle or a secondary particle in which a plurality of primary particles is aggregated. The mean particle diameter D₅₀ of the positive electrode active material may be, for example, greater than or equal to 1 nm, greater than or equal to 5 nm, or greater than or equal to 10 nm, and may be less than or equal to 500 μm, less than or equal to 100 μm, less than or equal to 50 μm, or less than or equal to 30 μm. The mean particle diameter D₅₀ is the particle diameter (median diameter) at an integrated value of 50% in the volume-based particle size distribution determined by the laser diffraction/scattering method.

For the solid electrolyte, the conductive auxiliary agent, and the binder that can be included in the cathode active material layer, reference can be made to the description of “anode active material layer”.

The shape of the cathode active material layer is not particularly limited, but may be, for example, a sheet-like cathode active material layer having a substantially flat surface. The thickness of the cathode active material layers is not particularly limited, but may be, for example, 0.1 μm or more, 1 μm or more, or 10 μm or more, and may be 2 mm or less, 1 mm or less, or 500 μm or less.

The cathode active material layer can be produced by applying a known method. For example, the cathode active material layer can be easily formed by, for example, dry or wet molding of a positive electrode mixture containing the above-described various components. The cathode active material layer may be formed together with the positive electrode current collector layer, or may be formed separately from the positive electrode current collector layer.

### Positive Electrode Current Collector Layer

A material used for the positive electrode current collector layer is not particularly limited, but a material generally used as a positive electrode current collector of a battery can be appropriately adopted. Examples of materials used for the positive electrode current collector layers include, but are not limited to, Cu, Ni, Cr, Au, Pt, Ag, Al, Fe, Ti, Zn, Co, and stainless-steel. Further, the positive electrode current collector layer may have some coating layer on the surface thereof for the purpose of adjusting the resistance or the like. The positive electrode current collector layer may be formed by plating or depositing the metal on a metal foil or a base material.

The shape of the positive electrode current collector layer is not particularly limited, but may be, for example, a foil shape, a plate shape, or a mesh shape. Among the above, the foil shape is preferred.

The thickness of the positive electrode current collector layers is not particularly limited, but may be 0.1 μm or more, or 1 μm or more, and may be 1 mm or less, or 100 μm or less.

While embodiments of the battery and method of manufacturing the battery of the present disclosure have been described, those skilled in the art will appreciate that changes can be made without departing from the scope of the claims.

What is claimed is:

1. A battery comprising a laminate in which an anode current collector layer, an anode active material layer, an electrolyte layer, and a cathode active material layer are laminated in a stated order, wherein in at least one end of the laminate,
a tip of the anode active material layer is located on an inner side of a tip of the anode current collector layer,
a tip of the electrolyte layer is located on an inner side of the tip of the anode active material layer,
a tip of the cathode active material layer is located on an inner side of the tip of the electrolyte layer,
an insulating end member is juxtaposed to an end face of the cathode active material layer, and
an end face of the electrolyte layer and an end face of the anode active material layer are covered with the insulating end member.

2. The battery according to claim 1, wherein the end face of the anode active material layer defines an inclined surface that approaches the anode current collector layer toward the tip of the anode active material layer.

3. The battery according to claim 1, wherein an angle between a tangential direction at a tip of the insulating end member and a surface direction of a surface of the anode current collector layer is 45° to 90°.

4. The battery according to claim 1, wherein an angle between a tangential direction at the tip of the cathode active material layer and a surface direction of a surface of the anode current collector layer is 30° to 110°.

5. A method of manufacturing the battery according to claim 1, the method comprising:
providing a preliminary laminate in which the anode current collector layer, the anode active material layer, and the electrolyte layer are laminated in the stated order; and
forming the insulating end member and the cathode active material layer simultaneously on the preliminary laminate, or forming the insulating end member and then the cathode active material layer on the preliminary laminate.
